(19) United States
(12) Patent Application Publication
(10) Pub. No.: US 2005/0001733 A1
(43) Pub. Date: Jan. 6, 2005

(54) Electric appliance, wireless remote control apparatus, and wireless electric appliance system

(76) Inventors: Yoichiro Tsuruta, Yokohama-shi (JP); Toshiya Kanamori, Yokohama-shi (JP); Yoshifumi Yuasa, Yokohama-shi (JP)

Correspondence Address: PEARNE & GORDON LLP, 1801 EAST 9TH STREET, SUITE 1200, CLEVELAND, OH, 44114-3108, US

(21) Appl. No.: 10/731,060

(22) Filed: Dec. 9, 2003

(30) Foreign Application Priority Data
Dec. 19, 2002 (JP) 2002-368351

(51) Int. Cl. G08C 19/00

(52) U.S. Cl. 340/825.72

(57) ABSTRACT

Herein disclosed is a wireless electric appliance system, comprising an electric appliance having assigned thereto a control code, and a wireless remote control apparatus having assigned thereto an operation code to be matched with the control code. The electric appliance is operably connected with the electric appliance. The electric appliance includes storage means for storing therein the control code; and transmitting means for transmitting a signal including the control code stored in the storage means to the wireless remote control apparatus. The wireless remote control apparatus includes storage means for storing therein the operation code; receiving means for receiving the signal including the control code assigned to the electric appliance from the electric appliance; judging means for judging whether or not the operation code stored in the storage means is matched with the control code of the signal received by the receiving means, and control means for controlling the operation of the wireless remote control apparatus based on a result judged by the judging means.

### BACKGROUND OF THE INVENTION

1. Field of the Invention

The present invention relates to a wireless electric appliance system, and more particularly to an electric appliance having a search signal transmitting unit for transmitting a search signal and a wireless remote control apparatus operative to provide location information correctly in response to the search signal.

2. Description of the Related Art

Up until now, there have been proposed a wide variety of wireless electric appliance systems each comprising an electric appliance having a search signal transmitting unit for transmitting a search signal and a wireless remote control apparatus operative to provide location information in response to the search signal for the purpose of being easily searched and found. The conventional wireless electric appliance systems thus proposed are disclosed in the Japanese Patent Application Laid-Open Publication No. H07-184286 and the Japanese Utility Model Publication No. H7-14782.

In FIG. 6 of the drawings, there is shown a conventional wireless electric appliance system 130 which comprises an electric appliance 110 and a wireless remote control apparatus 120. The electric appliance 110 includes an operation button 115 for allowing an operator to input a search instruction therethrough, and a radio signal transmitting unit 113 for transmitting a search signal to the wireless remote control apparatus 120 in response to the search instruction inputted through the operation button 115. The wireless remote control apparatus 120 includes a radio signal receiving unit 121 for receiving the search signal from the electric appliance 110 and a speaker unit 125 for outputting a sound indicative of the location thereof in accordance with the search signal received by the radio signal receiving unit 121.

The conventional wireless electric appliance system 130 thus constructed as previously mentioned, however, encounters a drawback that the speaker unit 125 tends to mistakenly output the sound when the radio signal receiving unit 121 receives a radio wave similar to the search signal transmitted from the electric appliance 110 under the condition that the wireless remote control apparatus 120 is located in the vicinity of electric devices transmitting radio waves.

### SUMMARY OF THE INVENTION

It is, therefore, an object of the present invention to provide a wireless electric appliance system comprising an electric appliance having a radio signal transmitting unit for transmitting a search signal and a wireless remote control apparatus operative to provide location information correctly in response to the search signal, thereby making it possible for the wireless electric appliance system to prevent the wireless remote control apparatus from mistakenly providing the location information in response to a radio wave other than the search signal even though the wireless remote control apparatus is located in the vicinity of electric devices transmitting radio waves.

It is another object of the present invention to provide an electric appliance having a radio signal transmitting unit for transmitting a search signal to a wireless remote control apparatus wherein the search signal transmitted by the electric appliance can be uniquely identified by the wireless remote control apparatus, thereby preventing the wireless remote control apparatus from mistakenly providing the location information in response to a radio wave other than the search signal even though the wireless remote control apparatus is located in the vicinity of electric devices transmitting radio waves.

It is a further object of the present invention to provide a wireless remote control apparatus operative to provide location information correctly in response to a search signal transmitted from an electric appliance thereby making it possible to prevent the wireless remote control apparatus from mistakenly providing the location information in response to a radio wave other than the search signal even though the wireless remote control apparatus is located in the vicinity of electric devices transmitting radio waves.

In accordance with a first aspect of the present invention, there is provided an electric appliance having a control code assigned thereto, and operably connected with a wireless remote control apparatus, comprising: storage means for storing therein the control code; and transmitting means for transmitting a signal including the control code stored in the storage means to the wireless remote control apparatus. The wireless remote control apparatus has assigned thereto an operation code to be matched with the control code. In the aforementioned electric appliance, the storage means may have stored therein a predetermined code as the control code assigned to the electric appliance.

The aforementioned electric appliance may further comprise control code generating means for generating a code. In the electric appliance, the storage means may be operative to store therein the code generated by the control code generating means as the control code, and the transmitting means may be operative to transmit a registration signal including the control code stored in the storage means to the wireless remote control apparatus. The control code generating means may be operative to generate a random number, and the storage means may be operative to store therein the random number generated by the control code generating means as the control code.

In accordance with a second aspect of the present invention, there is provided a wireless remote control apparatus having an operation code assigned thereto, and operably connected with an electric appliance having a control code assigned thereto, comprising: information providing means for providing information indicative of location of the wireless remote control apparatus; storage means for storing therein the operation code; receiving means for receiving a search signal including the control code assigned to the electric appliance from the electric appliance; judging means for judging whether or not the operation code stored in the storage means is matched with the control code on the basis of the search signal received by the receiving means; and control means for controlling the information providing means to have the information providing means provide information indicative of location of the wireless remote control apparatus based on a result judged by the judging means.

In the aforementioned wireless remote control apparatus, the receiving means may be operative to receive a registration signal including the control code assigned to the electric appliance from the electric appliance; and the control means may be operative to control the storage means to have the storage means store therein the control code as the operation code assigned to the wireless remote control apparatus in response to the registration signal.

In accordance with a third aspect of the present invention, there is provided a wireless electric appliance system comprising an electric appliance having assigned thereto a control code, and a wireless remote control apparatus having assigned thereto an operation code to be matched with the control code, the electric appliance being operably connected with the wireless remote control apparatus. The electric appliance includes storage means for storing therein the control code; and transmitting means for transmitting a signal including the control code stored in the storage means to the wireless remote control apparatus. The wireless remote control apparatus includes storage means for storing therein the operation code; receiving means for receiving the signal including the control code assigned to the electric appliance from the electric appliance; judging means for judging whether or not the operation code stored in the storage means is matched with the control code of the signal received by the receiving means, and control means for controlling the operation of the wireless remote control apparatus based on a result judged by the judging means.

In the aforementioned wireless electric appliance system, the electric appliance may further include control code generating means for generating a code. The storage means may be operative to store therein the code generated by the control code generating means as the control code, and the transmitting means may be operative to transmit a registration signal including the control code stored in the storage means to the wireless remote control apparatus. In the wireless remote control apparatus, the receiving means may be operative to receive the registration signal including the control code from the electric appliance, and the control means may be operative to control the storage means to have the storage means store therein the control code of the registration signal received by the receiving means as the operation code in response to the registration signal.

The electric appliance may further includes: inputting means for inputting a search instruction therethrough; and control means for controlling the transmitting means to have the transmitting means transmit a search signal including the control code to the wireless remote control apparatus in response to the search instruction inputted by the inputting means. The wireless remote control apparatus may further include information providing means for providing information indicative of location of the wireless remote control apparatus; and in the wireless remote control apparatus. The receiving means may be operative to receive the search signal including the control code from the electric appliance, the judging means may be operative to judge whether or not the operation code stored in the storage means is matched with the control code, and the control means may be operative to control the information providing means to have the information providing means provide information indicative of location of the wireless remote control apparatus based on a result judged by the judging means.

### BRIEF DESCRIPTION OF THE DRAWINGS

The present invention and many of the attendant advantages thereof will be better understood from the following detailed description when considered in connection with the accompanying drawings, wherein:

FIG. 1 is a block diagram of the wireless electric appliance system according to the present invention;

FIG. 2 is a flowchart of a registration process performed by the electric appliance forming part of the wireless electric appliance system according to the present invention;

FIG. 3 is a flowchart of a registration process performed by the wireless remote control apparatus forming part of the wireless electric appliance system according to the present invention;

FIG. 4 is a flowchart of a search process performed by the electric appliance forming part of the wireless electric appliance system according to the present invention;

FIG. 5 is a flowchart of a search process performed by the wireless remote control apparatus forming part of the wireless electric appliance system according to the present invention; and

FIG. 6 is a block diagram of the conventional wireless electric appliance system.

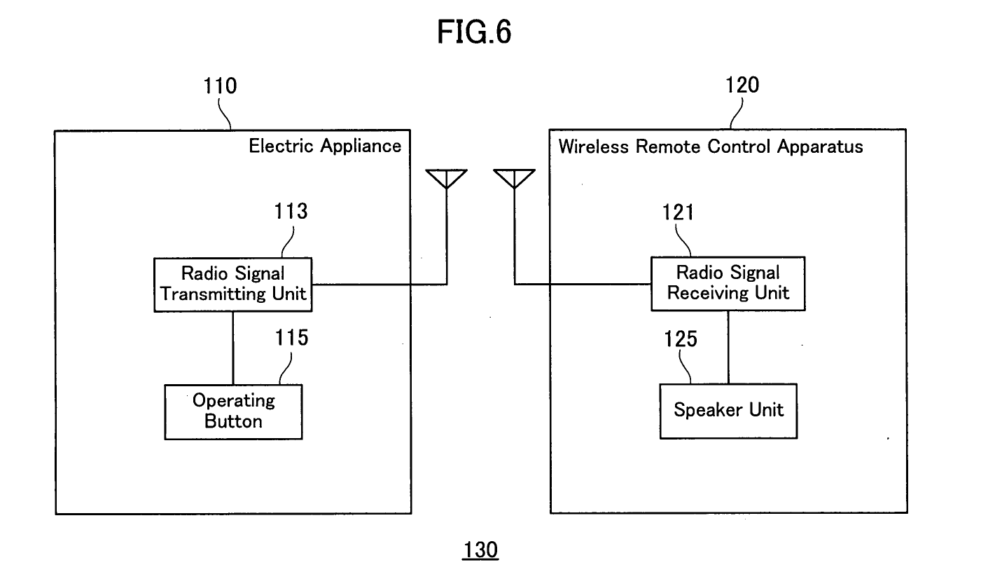

### DESCRIPTION OF THE PREFERRED EMBODIMENTS

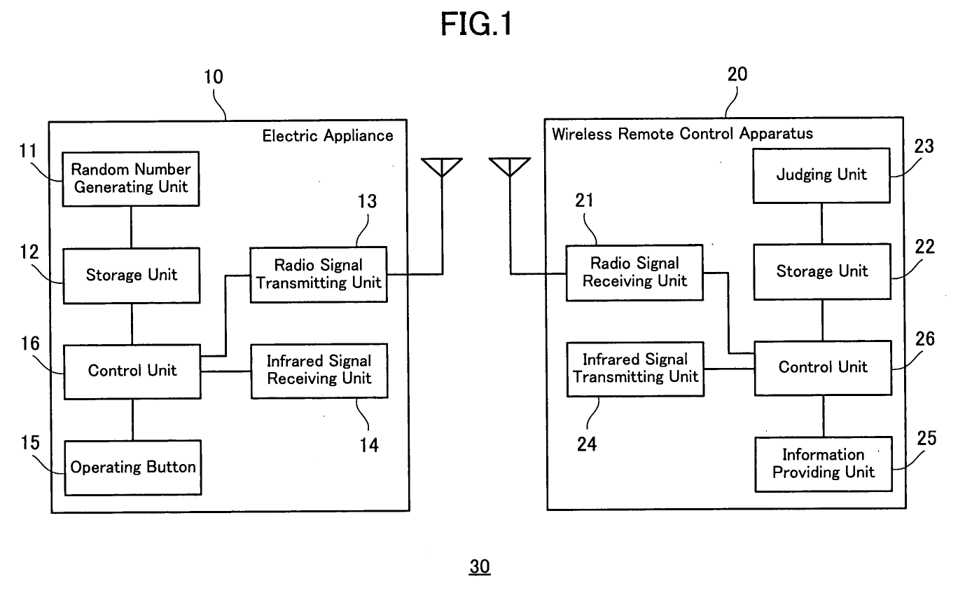

The following description will be directed to a preferred embodiment of the wireless electric appliance system comprising an electric appliance and a wireless remote control apparatus according to the present invention with reference to FIG. 1 to 5.

The construction of the wireless electric appliance system 30 comprising an electric appliance 10 and a wireless remote control apparatus 20 according to the present invention will firstly be described.

Referring to FIG. 1 of the drawings, there is shown a wireless electric appliance system 30 comprises an electric appliance 10 and a wireless remote control apparatus 20 operably connected with the electric appliance 10. The electric appliance 10 and the wireless remote control apparatus 20 have respectively assigned thereto a control code and an operation code.

The electric appliance 10 comprises a random number generating unit 11 for generating a random number, a storage unit 12 for storing therein the random number generated by the random number generating unit 11 as a control code to be assigned to the electric appliance 10, a radio signal transmitting unit 13 for transmitting a radio signal to the wireless remote control apparatus 20, an infrared signal receiving unit 14 for receiving an infrared signal from the wireless remote control apparatus 20, and an operation button 15 for inputting an operation instruction therethrough. The electric appliance 10 is designed to perform various functions in accordance with the infrared signal thus received. The operation instruction includes a registration instruction and a search instruction. In response to the registration instruction and the search instruction, the radio signal transmitting unit 13 is designed to respectively transmit a registration signal and a search signal. Each of the registration signal and the search signal include the control signal assigned to the electric appliance 10. The random number generating unit 11, the storage unit 12, and the radio signal transmitting unit 13 respectively constitute control code generating means, storage means and transmitting means of the electric appliance 10 forming part of the wireless electric appliance system 30 according to the present invention. The electric appliance 10 further comprises a control unit 16 for controlling the whole process in the electric appliance 10. The control unit 16 is operative to control the radio signal transmitting unit 13 to have the radio signal transmitting unit 13 transmit a search signal including the control code to the wireless remote control apparatus 20 in response to the search instruction inputted by the operation button 15.

The wireless remote control apparatus 20 comprises a radio signal receiving unit 21 for receiving a radio signal. The radio signal received by the radio signal receiving unit 21 may include a registration signal or a search signal having the control code assigned to the electric appliance 10. The wireless remote control apparatus 20 further comprises a storage unit 22 for storing therein an operation code assigned to the wireless remote control apparatus 20. The operation code assigned to the wireless remote control apparatus 20 is to be matched with the control code assigned to the electric appliance 10. The wireless remote control apparatus 20 further comprises a judging unit 23 for judging whether or not the control code included in the radio signal received by the radio signal receiving unit 21 is matched with the operation code stored in the storage unit 22, an infrared signal transmitting unit 24 for transmitting an infrared signal to the electric appliance 10 to operate the electric appliance 10, and an information providing unit 25 for providing information indicative of location of the wireless remote control apparatus 20. The information providing unit 25 may be constituted by, for example, a beeper, an electro luminescence (EL), or the like. The wireless remote control apparatus 20 further comprises a control unit 26 for controlling the whole process in the wireless remote control apparatus 20. The control unit 26 is operative to control the operation of the wireless remote control apparatus 20 based on a result judged by the judging unit 23 in accordance with the radio signal received by the radio signal receiving unit 21. The radio signal receiving unit 21, the storage unit 22, the judging unit 23, the information providing unit 25, and the control unit 26 respectively constitute receiving means, storage means, judging means, information providing means, and control means of the wireless remote control apparatus 20 forming part of the wireless electric appliance system 30 according to the present invention.

As will be seen from the foregoing description, the electric appliance 10 according to the present invention, having a control code assigned thereto, and operably connected with a wireless remote control apparatus 20, comprising: storage means constituted by a storage unit 12 for storing therein the control code; and transmitting means constituted by a radio signal transmitting unit 13 for transmitting a signal including the control code stored in the storage means to the wireless remote control apparatus 20, the wireless remote control apparatus 20 having assigned thereto an operation code to be matched with the control code assigned to the electric appliance 10, makes it possible for the wireless remote control apparatus 20 to uniquely identify the electric appliance 10, thereby enabling to prevent the wireless remote control apparatus 20 from mistakenly providing the location information in response to a radio wave other than the search signal even though the wireless remote control apparatus is located in the vicinity of electric devices transmitting radio waves.

According to the present invention, the wireless remote control apparatus 20 having an operation code assigned thereto, and operably connected with an electric appliance 10 having a control code assigned thereto, comprising: information providing means constituted by an information providing unit 25 for providing information indicative of location of the wireless remote control apparatus 20; storage means constituted by a storage unit 22 for storing therein the operation code; receiving means constituted by a radio signal receiving unit 21 for receiving a search signal including the control code assigned to the electric appliance 10 from the electric appliance 10; judging means constituted by a judging unit 23 for judging whether or not the operation code stored in the storage means is matched with the control code on the basis of the search signal received by the receiving means; and control means constituted by a control unit 26 for controlling the information providing means to have the information providing means provide information indicative of location of the wireless remote control apparatus 20 based on a result judged by the judging means, can provide location information correctly in response to the search signal transmitted from the electric appliance 10, thereby making it possible to prevent the wireless remote control apparatus from mistakenly providing the location information in response to a radio wave other than the search signal even though the wireless remote control apparatus is located in the vicinity of electric devices transmitting radio waves.

The operation of the wireless electric appliance system 30 comprising an electric appliance 10 and a wireless remote control apparatus 20 forming part of the wireless electric system 30 according to the present invention will be described hereinlater.

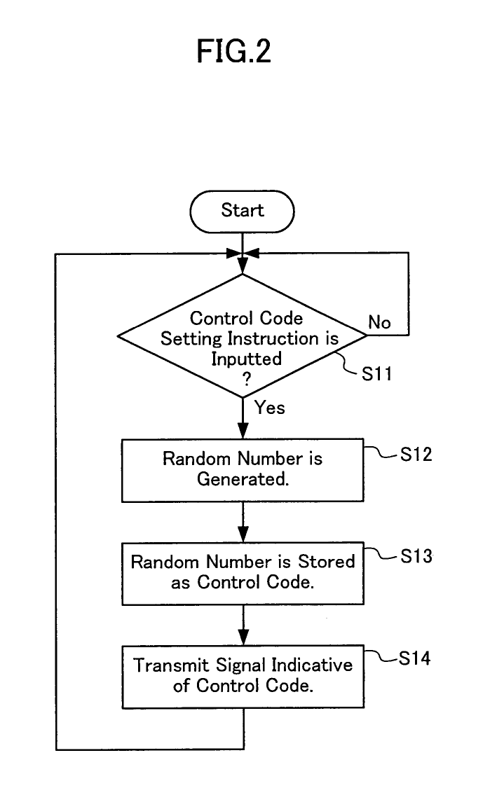

The following description will now be directed to a registration process performed by the electric appliance 10 forming part of the wireless electric appliance system 30 according to the present invention with reference to FIG. 2. The whole process is controlled by the control unit 16 of the electric appliance 10.

In the step S11, it is judged whether or not an operation instruction is inputted through the operation button 15. When it is judged that the operation instruction is inputted, the step S11 goes forward to the step S12, in which a random number is generated by the random number generating unit 11. The step S12 goes forward to the step S13, in which the random number generated by the random number generating unit 11 is stored in the storage unit 12 as a control code to be assigned to the electric appliance 10. The step S13 goes forward to the step S14, in which a registration signal including the control code stored in the storage unit 12 is transmitted to the wireless remote control apparatus 20. The step S14 goes back to the step S11.

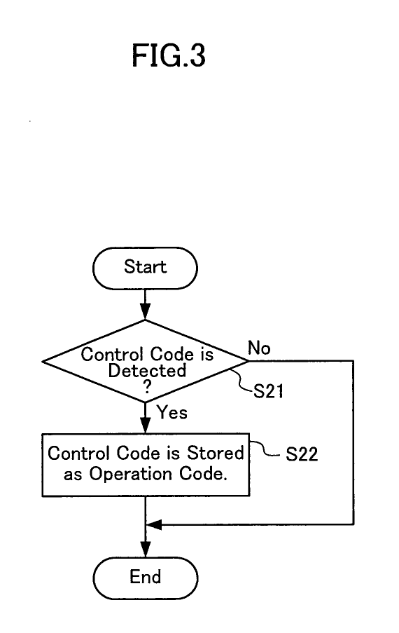

The following description will now be directed to a registration process performed by the wireless remote control apparatus 20 forming part of the wireless electric appliance system 30 according to the present invention with reference to FIG. 3. The whole process is controlled by the control unit 26 of the wireless remote control apparatus 20.

In the step S21, the registration signal is received by the radio signal receiving unit 21, and it is judged whether or not the control code is detected. When it is judged that the control code is detected, the step S21 goes forward to the step S22, in which the control code is stored in the storage unit 22 as an operation code to be assigned to the wireless remote control apparatus 20. The step S22 goes to END. When it is, on the other hand, judged that the control code is not detected, the step S21 goes to END.

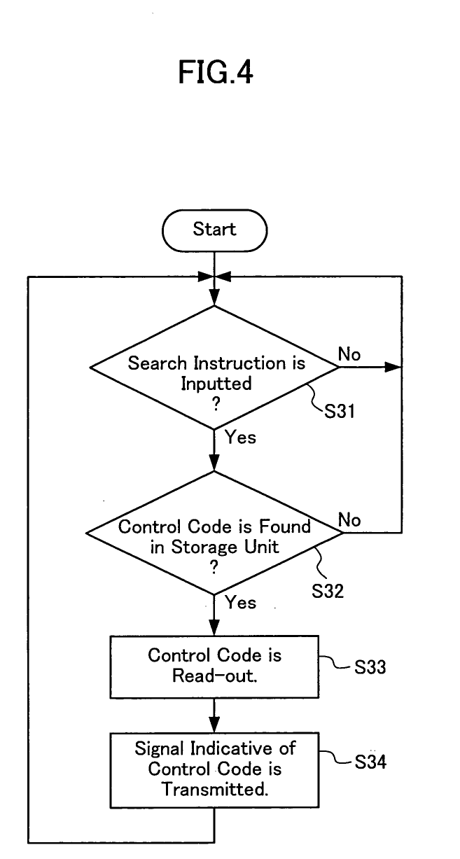

The following description will now be directed to a search process performed by the electric appliance 10 forming part of the wireless electric appliance system 30 according to the present invention with reference to FIG. 4. The whole process is controlled by the control unit 16 of the electric appliance 10.

In the step S31, it is judged whether or not a search instruction is inputted through the operation button 15. When it is judged that the search instruction is inputted through the operation button 15, the step S31 goes forward to the step S32, in which it is judged whether or not the control code is stored in the storage unit 12. When it is judged that the control code is stored in the storage unit 12, the steps 32 goes forward to the step S33. When it is, on the other hand, judged that the control code is not stored in the storage unit 12, the steps 32 goes back to the step S31. In the step S33, the control code stored in the storage unit 12 is read out. The step S33 goes forward to the step S34, in which a search signal including the control code thus read out is transmitted to the wireless remote control apparatus 20. The step S34 goes back to the step S31.

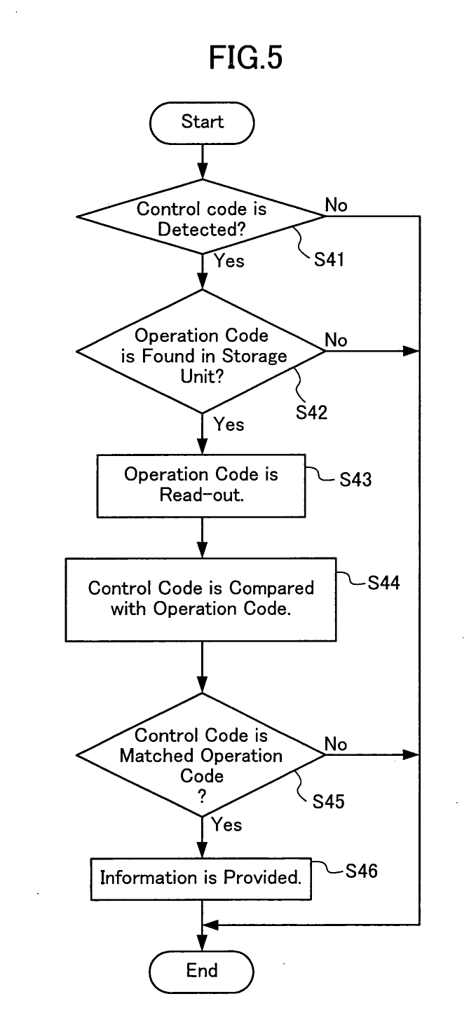

The following description will now be directed to a search process performed by the wireless remote control apparatus 20 forming part of the wireless electric appliance system 30 according to the present invention with reference to FIG. 5. The whole process is controlled by the control unit 26 of the wireless remote control apparatus 20.

In the step S41, the search signal is received by the radio signal receiving unit 21, and it is judged whether or not the control code is detected. When it is judged that the control code is detected, the step S41 goes forward to the step S42. When it is, on the other hand, judged that the control code is not detected, the step S41 goes to END. In the step S42, it is judged whether or not the operation code is stored in the storage unit 22. When it is judged that the operation code is stored in the storage unit 22, the steps 42 goes forward to the step S43. When it is, on the other hand, judged that the control code is not stored in the storage unit 22, the steps 42 goes to END. In the step S43, the operation code stored in the storage unit 22 is read out. The step S43 goes forward to the step S44, in which the control code received in the step S41 is compared with the operation code read out in the step S43. The step S44 goes forward to the step S45, in which it is judged whether or not the control code is matched with the operation code. When it is judged that the control code is matched with the operation code, the step S45 goes forward to the step S46. When it is, on the other hand, judged that the control code is not matched with the operation code, the step S45 goes to END. In the step S46, the information providing unit 25 is operated to provide information indicative of the location of the wireless remote control apparatus 20. The step S46 goes to END.

Though it has been described in the above that the electric appliance 10 comprises a random number generating unit 11 for generating a random number to be used as a control code assigned to the electric appliance 10 and an operation code assigned to the wireless remote control apparatus 20, the wireless electric appliance system 30 according to the present invention may be constituted by any other means as long as the control code assigned to the electric appliance 10 can be matched with the operation code assigned to the wireless remote control apparatus 20. This means that, for example, the storage unit 12 of the electric appliance 10 and the storage unit 22 of the wireless remote control apparatus 20 may respectively have stored therein a predetermined control code and a predetermined operation code, which are matched with each other.

While it has been described in the above that the electric appliance 10 comprises an operation button 15 for inputting an operation instruction therethrough, and the random number generating unit 11 is operative to generate a random number in response to the registration instruction inputted through the operation button 15, the wireless electric appliance system 30 according to the present invention may be constituted by any other means as long as the random number generating unit 11 can be operative to generate a random number in response to a registration instruction. This means that, for example, the wireless remote control apparatus 20 may comprises an operation button for inputting an operation instruction therethrough, and the infrared signal transmitting unit 24 may be operative to transmit an infrared signal including the registration instruction in response to the operation instruction thus inputted, and the infrared signal receiving unit 14 of the electric appliance 10 may be operative to receive the infrared signal having the registration instruction from the wireless remote control apparatus 20, and the random number generating unit 11 of the electric appliance 10 may be operative to generate a random number in response to the registration instruction thus received.

From the foregoing description, it is to be understood that the wireless electric appliance system 30 according to the present invention, comprising an electric appliance 10 having assigned thereto a control code, and a wireless remote control apparatus 20 having assigned thereto an operation code to be matched with the control code, the electric appliance 10 being operably connected with the wireless remote control apparatus 20, the electric appliance 10 including storage means constituted by the storage unit 12 for storing therein the control code; and transmitting means constituted by a radio signal transmitting unit 13 for transmitting a signal including the control code stored in the storage means to the wireless remote control apparatus 20, the wireless remote control apparatus 20 including: storage means constituted by a storage unit 22 for storing therein the operation code; receiving means constituted by a radio signal receiving unit 21 for receiving the signal including the control code from the electric appliance 10, judging means constituted by a judging unit 23 for judging whether or not the operation code stored in the storage means is matched with the control code of the signal received by the receiving means, and control means constituted by a control unit 26 for controlling the operation of the wireless remote control apparatus 20 based on a result judged by the judging means, makes it possible for the wireless remote control apparatus 20 to uniquely identify the electric appliance 10, thereby enabling to prevent the wireless remote control apparatus 20 from mistakenly providing the location information in response to a radio wave other than the search signal even though the wireless remote control apparatus is located in the vicinity of electric devices transmitting radio waves.

Furthermore, in the wireless electric appliance system according to the present invention, the electric appliance 10 further includes: inputting means constituted by an operation button 15 for inputting a search instruction therethrough; and control means constituted by a control unit 16 for controlling the transmitting means constituted by the radio signal transmitting unit 13 to have the transmitting means transmit a search signal including the control code to the wireless remote control apparatus 20 in response to the search instruction inputted by the inputting means, the wireless remote control apparatus 20 further includes: information providing means constituted by an information providing unit 25 for providing information indicative of location of the wireless remote control apparatus 20, and in the wireless remote control apparatus 20, the receiving means constituted by the radio signal receiving unit 21 is operative to receive the search signal including the control code from the electric appliance 10, the judging means constituted by the judging unit 23 is operative to judge whether or not the operation code stored in the storage means is matched with the control code of the search signal received by the receiving means, and the control means constituted by the control unit 26 is operative to control the information providing means constituted by the information providing unit 25 to have the information providing means provide information indicative of location of the wireless remote control apparatus 20 based on a result judged by the judging means, makes it possible for the wireless electric appliance system to prevent the wireless remote control apparatus from mistakenly providing the location information in response to a radio wave other than the search signal even though the wireless remote control apparatus is located in the vicinity of electric devices transmitting radio waves.

It will be understood by those skilled in the art that the foregoing description is in terms of preferred embodiment of the present invention wherein various changes and modification may be made without departing from the spirit and scope of the invention, as set forth in the appended claims.

1. An electric appliance having a control code assigned thereto, and operably connected with a wireless remote control apparatus, comprising: storage means for storing therein said control code; and transmitting means for transmitting a signal including said control code stored in said storage means to said wireless remote control apparatus, said wireless remote control apparatus having assigned thereto an operation code to be matched with said control code.

2. An electric appliance as set forth in claim 1, in which said storage means has stored therein a predetermined code as said control code.

3. An electric appliance as set forth in claim 1, further comprising: control code generating means for generating a code, and in which said storage means is operative to store therein said code generated by said control code generating means as said control code, and said transmitting means is operative to transmit a registration signal including said control code stored in said storage means to said wireless remote control apparatus.

4. An electric appliance as set forth in claim 3, in which said control code generating means is operative to generate a random number, and said storage means is operative to store therein said random number generated by said control code generating means as said control code.

5. A wireless remote control apparatus having an operation code assigned thereto, and operably connected with an electric appliance having a control code assigned thereto, comprising: information providing means for providing information indicative of location of said wireless remote control apparatus; storage means for storing therein said operation code; receiving means for receiving a search signal including said control code assigned to said electric appliance from said electric appliance; judging means for judging whether or not said operation code stored in said storage means is matched with said control code on the basis of said search signal received by said receiving means; and control means for controlling said information providing means to have said information providing means provide information indicative of location of said wireless remote control apparatus based on a result judged by said judging means.

6. A wireless remote control apparatus as set forth in claim 5, in which said receiving means is operative to receive a registration signal including said control code assigned to said electric appliance from said electric appliance; and said control means is operative to control said storage means to have said storage means store therein said control code as said operation code in response to said registration signal.

7. A wireless electric appliance system comprising an electric appliance having assigned thereto a control code, and a wireless remote control apparatus having assigned thereto an operation code to be matched with said control code, said electric appliance being operably connected with said wireless remote control apparatus, said electric appliance including: storage means for storing therein said control code; and transmitting means for transmitting a signal including said control code stored in said storage means to said wireless remote control apparatus, said wireless remote control apparatus including: storage means for storing therein said operation code; receiving means for receiving said signal including said control code assigned to said electric appliance from said electric appliance; judging means for judging whether or not said operation code stored in said storage means is matched with said control code of said signal received by said receiving means, and control means for controlling the operation of said wireless remote control apparatus based on a result judged by said judging means.

8. A wireless electric appliance system as set forth in claim 7, in which said electric appliance further includes: control code generating means for generating a code, said storage means is operative to store therein said code generated by said control code generating means as said control code, and said transmitting means is operative to transmit a registration signal including said control code stored in said storage means to said wireless remote control apparatus, and in said wireless remote control apparatus, said receiving means is operative to receive said registration signal including said control code from said electric appliance, and said control means is operative to control said storage means to have said storage means store therein said control code of said registration signal received by said receiving means as said operation code in response to said registration signal.

9. A wireless electric appliance system as set forth in claim 7, in which said electric appliance further includes: inputting means for inputting a search instruction therethrough; and control means for controlling said transmitting means to have said transmitting means transmit a search signal including said control code to said wireless remote control apparatus in response to said search instruction inputted by said inputting means, said wireless remote control apparatus further includes: information providing means for providing information indicative of location of said wireless remote control apparatus; and in said wireless remote control apparatus, said receiving means is operative to receive said search signal including said control code from said electric appliance, said judging means is operative to judge whether or not said operation code stored in said storage means is matched with said control code of said search signal received by said receiving means, and said control means is operative to control said information providing means to have said information providing means provide information indicative of location of said wireless remote control apparatus based on a result judged by said judging means.
